(19) United States
(12) Patent Application Publication
(10) Pub. No.: US 2024/0010192 A1
(43) Pub. Date: Jan. 11, 2024

(54) DEVICE AND METHOD FOR CONTROLLING DRIVING OF VEHICLE

(71) Applicants: Hyundai Motor Company, Seoul (KR); Kia Corporation, Seoul (KR)

(72) Inventors: Ji Hwan PARK, Seoul (KR); Chan Hee JUNG, Seoul (KR); Su Hong CHAE, Hwaseong-Si (KR); Young Jin SUNG, Seoul (KR)

(73) Assignees: Hyundai Motor Company, Seoul (KR); Kia Corporation, Seoul (KR)

(21) Appl. No.: 18/101,375

(22) Filed: Jan. 25, 2023

(30) Foreign Application Priority Data
Jul. 8, 2022 (KR) 10-2022-0084536

(51) Int. Cl. B60W 30/09; B60W 50/02; B60W 30/095; B60W 60/00

(52) U.S. Cl. CPC B60W 30/09; B60W 50/0205; B60W 30/095; B60W 60/0015; B60W 2050/0215

(57) ABSTRACT

A device for controlling driving of a vehicle includes a sensor for acquiring state information of the vehicle during autonomous driving, a processor that performs emergency braking when a risk of collision of the vehicle is predicted based on the obtained state information of the vehicle, stores a vehicle event when the vehicle event occurs after the emergency braking is performed, and transitions to a driving mode for resolving the vehicle event when the risk of collision is resolved, and storage for storing an algorithm for an operation of the processor.

### CROSS-REFERENCE TO RELATED APPLICATION

The present application claims priority to Korean Patent Application No. 10-2022-0084536, filed on Jul. 8, 2022, the entire contents of which is incorporated herein for all purposes by this reference.

### BACKGROUND OF THE PRESENT DISCLOSURE

### Field of the Present Disclosure

The present disclosure relates to a device and a method for controlling driving of a vehicle.

### Description of Related Art

An autonomous emergency braking system mounted on an autonomous vehicle is a device that delivers a dangerous situation to a driver when recognizing a vehicle or an obstacle in front of the vehicle which is being autonomously driven and predicting a collision, and prevents the collision as the vehicle automatically operates a brake when the driver does not intervene.

In general, the autonomous vehicle automatically returns to a previous driving mode (e.g., an autonomous driving mode) when a risk of collision is eliminated after emergency braking is performed, so that, even when an event occurs in the vehicle after the emergency braking is performed, the vehicle returns to the previous driving mode in a state in which the vehicle event has not been resolved, degrading safety of the autonomous driving vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device and a method for controlling driving of a vehicle configured to resolve a vehicle event when the vehicle event occurs after emergency braking is performed.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device configured to control driving of a vehicle includes a sensor configured to obtain state information of the vehicle during autonomous driving, a processor that performs emergency braking when a risk of collision of the vehicle is predicted based on the obtained state information of the vehicle, stores a vehicle event when the vehicle event occurs after the emergency braking is performed, and transitions to a driving mode for resolving the vehicle event when the risk of collision is resolved, and storage configured to store an algorithm for an operation of the processor.

In an exemplary embodiment of the present disclosure, the vehicle event may include an event occurring when the state information of the vehicle is not able to be obtained because of contamination of the sensor or a malfunction of the sensor.

In an exemplary embodiment of the present disclosure, the processor is configured to determine whether a pre-stored vehicle event exists after the emergency braking is performed.

In an exemplary embodiment of the present disclosure, the processor is configured to determine whether the vehicle event has occurred when the pre-stored vehicle event does not exist after the emergency braking is performed.

In an exemplary embodiment of the present disclosure, the processor is configured to determine whether the risk of collision has been resolved when the processor concludes that the pre-stored vehicle event exists after the emergency braking is performed.

In an exemplary embodiment of the present disclosure, the processor may maintain the emergency braking when the processor concludes that the risk of collision has not been resolved.

In an exemplary embodiment ofthe present disclosure, the processor may store the vehicle event when the vehicle event occurs after the emergency braking is performed, and transition to a minimum risk maneuver (MRM) mode when the risk of collision is resolved.

In an exemplary embodiment of the present disclosure, the minimum risk maneuver may include stopping of the vehicle after decelerating or stopping of the vehicle after a lane change to a shoulder.

In an exemplary embodiment of the present disclosure, the sensor includes at least one of an image sensor, a Light Detection and Ranging (LiDAR), an accelerator pedal sensor, an emergency light sensor, a door sensor, a rain sensor, an air pressure sensor, a belt sensor, a wheel speed sensor, a yaw rate sensor, a cylinder pressure sensor, a steering wheel sensor, or any combination of each sensor.

In an exemplary embodiment of the present disclosure, the vehicle event may include an event occurring because of a failure of a device within the vehicle.

According to another aspect of the present disclosure, a method for controlling driving of a vehicle includes obtaining state information of the vehicle during autonomous driving, performing emergency braking of the vehicle when a risk of collision of the vehicle is predicted based on the obtained state information of the vehicle, storing a vehicle event when the vehicle event occurs after the emergency braking is performed, and transitioning to a driving mode for resolving the vehicle event when the risk of collision is resolved.

In an exemplary embodiment of the present disclosure, wherein the vehicle event includes an event occurring when the state information of the vehicle is not able to be obtained because of contamination of a sensor for acquiring the state information of the vehicle or a malfunction of the sensor.

In an exemplary embodiment of the present disclosure, the method may further include determining whether a pre-stored vehicle event exists after the emergency braking is performed.

In an exemplary embodiment of the present disclosure, the method may further include determining whether the vehicle event has occurred when the pre-stored vehicle event does not exist after the emergency braking is performed.

In an exemplary embodiment of the present disclosure, the method may further include determining whether the risk of collision has been resolved when the processor concludes that the pre-stored vehicle event exists after the emergency braking is performed.

In an exemplary embodiment of the present disclosure, the method may further include maintaining the emergency braking when the processor concludes that the risk of collision has not been resolved.

In an exemplary embodiment of the present disclosure, the vehicle event may be stored when the vehicle event occurs after the emergency braking is performed, and a driving mode may transition to a minimum risk maneuver (MRM) mode when the risk of collision is resolved.

In an exemplary embodiment of the present disclosure, the minimum risk maneuver may include stopping of the vehicle after decelerating or stopping of the vehicle after a lane change to a shoulder.

In an exemplary embodiment ofthe present disclosure, the sensor includes at least one of an image sensor, a LiDAR, an accelerator pedal sensor, an emergency light sensor, a door sensor, a rain sensor, an air pressure sensor, a belt sensor, a wheel speed sensor, a yaw rate sensor, a cylinder pressure sensor, a steering wheel sensor, or any combination of each sensor. In an exemplary embodiment of the present disclosure, the vehicle event may include an event occurring because of a failure of a device within the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a configuration of a vehicle driving control device according to an exemplary embodiment of the present disclosure;

FIG. 2 is a diagram illustrating a vehicle driving control method according to an exemplary embodiment of the present disclosure;

FIG. 3 is a diagram illustrating a configuration of a computing system executing a method according to an exemplary embodiment of the present disclosure; and

FIG. 4 is a diagram illustrating a configuration of a vehicle driving control device according to another exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to a same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

In describing the components of the exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as including a meaning which is consistent with their meaning in the context of the relevant art and will not be interpreted in an idealized or overly formal sense unless expressly so defined herein.

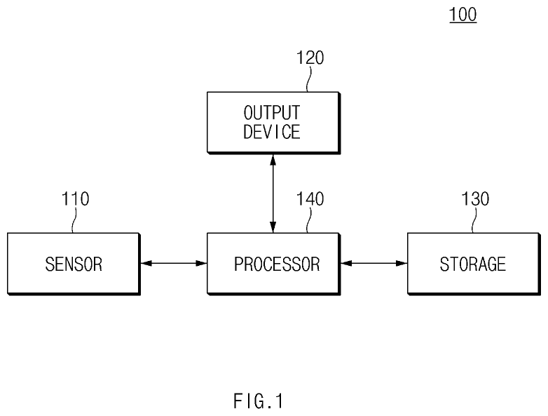

FIG. 1 is a diagram illustrating a configuration of a vehicle driving control device according to an exemplary embodiment of the present disclosure.

As shown in FIG. 1, a vehicle driving control device 100 according to an exemplary embodiment of the present disclosure may include a sensor 110, an output device 120, storage 130, and a processor 140.

The sensor 110 may obtain vehicle state information, driving information, and driver state information during autonomous driving. To the present end, the sensor 110 may include a wheel sensor, a speed sensor, an inclination sensor, a weight detecting sensor, a heading sensor, a yaw sensor, a gyro sensor, a position module, a vehicle forward/backward movement sensor, a battery sensor, a fuel sensor, a tire sensor, a steering wheel sensor, a vehicle interior temperature sensor, a vehicle interior humidity sensor, an ultrasonic sensor, an illuminance sensor, a radar, a LiDAR, and the like. Accordingly, the sensor 110 may obtain detection signals for vehicle direction information, vehicle location information (GPS information), vehicle angle information, vehicle speed information, vehicle acceleration information, vehicle inclination information, vehicle forward/backward movement information, battery information, fuel information, tire information, vehicle lamp information, vehicle interior temperature information, vehicle interior humidity information, a steering wheel turning angle, a vehicle external illuminance, and the like. Furthermore, the sensor 110 may include an image sensor, and may obtain the driver state information therethrough.

The output device 120 may output an image, a sound, or a vibration in response to control of the processor 140. According to an exemplary embodiment of the present disclosure, the output device 120 may include a display device for outputting the image, and the display device may include a navigation display, a head up display (HUD), a cluster, and the like. The output device 120 may include a speaker for outputting the sound. Furthermore, the output device 120 may include a vibration output device for outputting the vibration, and the vibration output device may be disposed on a seat or a steering wheel in a vehicle.

The storage 130 may store at least one algorithm for performing calculation or execution of various commands of the processor 140 for operation of the vehicle driving control device according to an exemplary embodiment of the present disclosure. The storage 130 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk. Furthermore, when a vehicle event occurs during emergency braking, the storage 130 may store the vehicle event under the control of the processor 140.

The processor 140 may be implemented by various processing devices such as a microprocessor including a semiconductor chip configured to perform the calculation or the execution of the various commands or the like, and may control the operation of the vehicle driving control device according to an exemplary embodiment of the present disclosure.

The processor 140 may control the vehicle to perform autonomous driving. The processor 140 may determine whether a risk of collision with an obstacle in front of the vehicle is predicted based on the driving information of the vehicle during the autonomous driving.

The processor 140 may warn a driver of the risk of collision when it is determined that the risk of collision with the obstacle in front of the vehicle is predicted, determine whether the driver is able to intervene based on the driver state information (e.g., a drowsy state), and perform the emergency braking during the autonomous driving when there is no driver intervention to resolve the risk of collision because the driver intervention is not possible.

The processor 140 may determine whether a pre-stored vehicle event exists after the emergency braking is performed. In this regard, the vehicle event may include an event occurred when the state information of the vehicle is not able to be obtained as the sensor 110 is contaminated (covered) due to a substance (a blockage) that blocks sensing or when the state information of the vehicle is not able to be obtained due to a malfunction of the sensor 110. Furthermore, the vehicle event may include an event that occurs when the state information of the vehicle is not able to be obtained because of contamination of a sensor for acquiring the state information of the vehicle or a malfunction of the sensor.

According to an exemplary embodiment of the present disclosure, when the image sensor (a camera), the LiDAR, an accelerator pedal sensor, an emergency light sensor, a door sensor, a rain sensor, an air pressure sensor, a belt sensor, a wheel speed sensor, a yaw rate sensor, a cylinder pressure sensor, the steering wheel sensor, and the like are malfunctioning or the substance (the blockage) that blocks the sensing is adsorbed, the processor 140 may not be able to normally obtain the state information of the vehicle, and may determine an event (a problem) resulted therefrom as the vehicle event.

Furthermore, when an electric/electronic device in the vehicle malfunctions, the processor 140 may determine an event resulted therefrom as the vehicle event. According to an exemplary embodiment of the present disclosure, the processor 140 may determine an event resulted from a malfunction of an engine management system (EMS), a transmission control unit (TCU), a cluster, an indoor camera, a wiper, a headlamp, an airbag, a pre-safe seat belt (PSB), a seat belt buckle, a steering wheel remote control (SWRC), a multifunction steering wheel (MFSW), a dual automatic temperature control (DATC), a head mount display (HMD), a hand-off detection (HOD), a global navigation satellite system (GNSS), a motor driven power steering (MDPS) as the vehicle event.

The processor 140 may determine whether the risk of collision has been resolved when the pre-stored vehicle event exists after the emergency braking is performed. When the pre-stored vehicle event exists and it is determined that the risk of collision has been resolved, the processor 140 may control a driving mode to transition to a driving mode to resolve the vehicle event, without transitioning to an autonomous driving mode, which is a driving mode before the emergency braking is performed. For example, the driving mode for resolving the vehicle event may include a minimum risk maneuver (MRM) mode. In this regard, a minimum risk maneuver may include stopping of the vehicle after decelerating or stopping of the vehicle after a lane change to a shoulder. This may improve safety of the autonomous driving by allowing the stored vehicle event to be resolved after the emergency braking.

On the other hand, when it is determined that the pre-stored vehicle event does not exist after the emergency braking is performed, the processor 140 may determine whether the vehicle event has occurred based on the driving information.

When it is determined that the vehicle event has occurred, the processor 140 may control the vehicle event to be stored in the storage 130.

The processor 140 may determine whether the risk of collision has been resolved when the vehicle event is stored. When it is determined that the risk of collision has been resolved after the vehicle event is stored, the processor 140 may control the driving mode to transition to the driving mode to resolve the stored vehicle event, without transitioning to the autonomous driving mode, which is the driving mode before the emergency braking is performed. This may improve the safety of the autonomous driving by allowing the stored vehicle event to be resolved after the emergency braking.

On the other hand, when it is determined that the vehicle event has not occurred, the processor 140 may determine whether the risk of collision has been resolved. When it is determined that the vehicle event has not occurred after the emergency braking and the risk of collision has been resolved, the processor 140 may control the vehicle to return to the autonomous driving mode, which is the driving mode before the emergency braking is performed.

However, when determining that the vehicle event has not occurred after the emergency braking and the risk of collision has not been resolved, the processor 140 may control the emergency braking to be maintained.

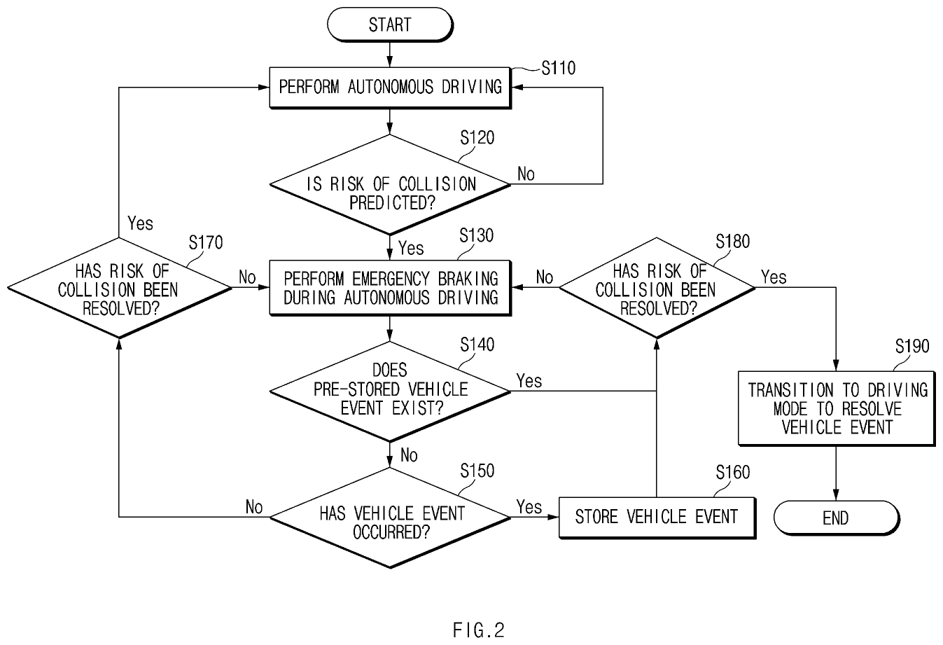

FIG. 2 is a diagram illustrating a vehicle driving control method according to an exemplary embodiment of the present disclosure.

As shown in FIG. 2, the processor 140 may control the vehicle to perform the autonomous driving (S110). The processor 140 may determine whether the risk of collision with the obstacle in front of the vehicle is predicted based on the driving information of the vehicle during the autonomous driving (S120).

When it is determined in S120 that the risk of collision with the obstacle in front of the vehicle is predicted, the processor 140 may warn the driver of the risk of collision, and may determine whether the driver is able to intervene based on the information of the driver.

When there is no driver intervention to resolve the risk of collision because the driver intervention is not possible, the processor 140 may perform the emergency braking during the autonomous driving (S130).

The processor 140 may determine whether the pre-stored vehicle event exists after the emergency braking is performed (S140). In this regard, the vehicle event may include the event that occurs when the state information of the vehicle is not able to be obtained because of contamination of a sensor for acquiring the state information of the vehicle or a malfunction of the sensor. For example, the vehicle event may include a tire air pressure drop event.

When the pre-stored vehicle event exists after the emergency braking is performed in S140 (Yes), the processor 140 may determine whether the risk of collision has been resolved (S180).

When it is determined in S180 that the pre-stored vehicle event exists and the risk of collision has been resolved (Yes), the processor 140 may control the driving mode to transition to the driving mode to resolve the vehicle event, without transitioning to the autonomous driving mode, which is the driving mode before the emergency braking is performed (S190). The driving mode to resolve the vehicle event in S190 may include the minimum risk maneuver (MRM) mode. In this regard, the minimum risk maneuver may include the stopping after the decelerating or the stopping after the lane change to the shoulder. Accordingly, the safety of the autonomous driving may be improved by allowing the stored vehicle event to be resolved after the emergency braking.

On the other hand, when it is determined in S140 that the pre-stored vehicle event does not exist after the emergency braking is performed (No), the processor 140 may determine whether the vehicle event has occurred based on the driving information (S150).

When it is determined in S150 that the vehicle event has occurred (Yes), the processor 140 may control the vehicle event to be stored in the storage 130 (S160).

The processor 140 may determine whether the risk of collision has been resolved when the vehicle event is stored (S180).

When it is determined in S180 that the risk of collision has been resolved after the vehicle event is stored, the processor 140 may control the driving mode to transition to the driving mode to resolve the stored vehicle event, without transitioning to the autonomous driving mode which is the driving mode before the emergency braking is performed (S190). The driving mode to resolve the vehicle event in S190 may include the minimum risk maneuver (MRM) mode when the risk of collision has been resolved. In this regard, the minimum risk maneuver may include the stopping after the decelerating or the stopping after the lane change to the shoulder. Accordingly, the safety of the autonomous driving may be improved by allowing the stored vehicle event to be resolved after the emergency braking.

On the other hand, when it is determined in S180 that the risk of collision has not been resolved (No), the processor 140 may control the emergency braking to be maintained (S130).

On the other hand, when it is determined in S150 that the vehicle event has not occurred (No), the processor 140 may determine whether the risk of collision has been resolved (S170).

When it is determined in S170 that the vehicle event has not occurred after the emergency braking and the risk of collision has been resolved (Yes), the processor 140 may control the vehicle to return to the autonomous driving mode, which is the driving mode before the emergency braking is performed (S110).

However, when it is determined in S170 that the vehicle event has not occurred after the emergency braking and the risk of collision has not been resolved (No), the processor 140 may control the emergency braking to be maintained (S130).

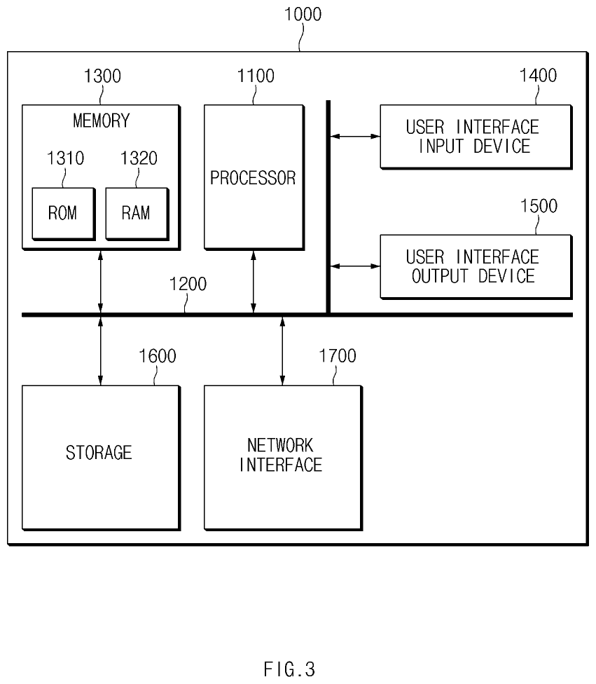

FIG. 3 is a diagram illustrating a configuration of a computing system executing a method according to an exemplary embodiment of the present disclosure.

Referring to FIG. 3, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

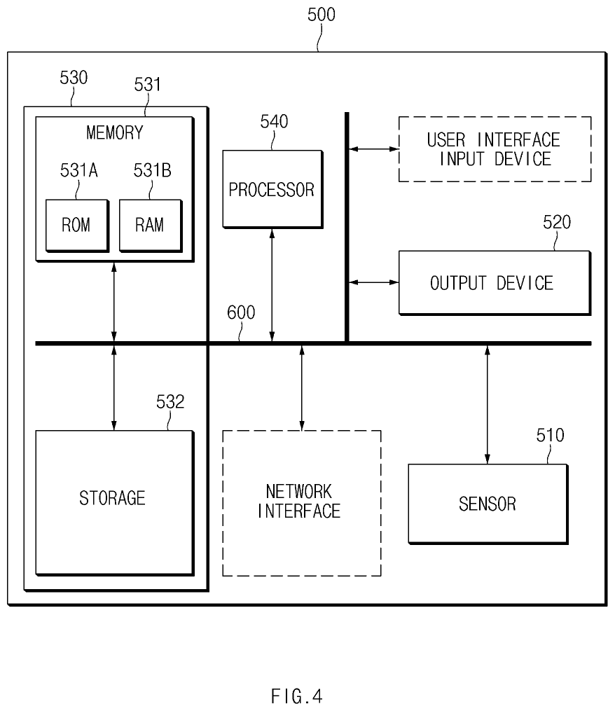

FIG. 4 is a diagram illustrating a configuration of a vehicle driving control device according to another exemplary embodiment of the present disclosure.

Referring to FIG. 4, a vehicle driving control device 500 according to another exemplary embodiment of the present disclosure may include a sensor 510, an output device 520, a storage device 530, and a processor 540 connected to each other via a bus 600.

The sensor 510 may obtain the vehicle state information, the driving information, and the driver state information during the autonomous driving. To the present end, the sensor 510 may include a wheel sensor, a speed sensor, an inclination sensor, a weight detecting sensor, a heading sensor, a yaw sensor, a gyro sensor, a position module, a vehicle forward/backward movement sensor, a battery sensor, a fuel sensor, a tire sensor, a steering wheel sensor, a vehicle interior temperature sensor, a vehicle interior humidity sensor, an ultrasonic sensor, an illuminance sensor, a radar, a LiDAR, and the like. Accordingly, the sensor 510 may obtain detection signals for vehicle direction information, vehicle location information (GPS information), vehicle angle information, vehicle speed information, vehicle acceleration information, vehicle inclination information, vehicle forward/backward movement information, battery information, fuel information, tire information, vehicle lamp information, vehicle interior temperature information, vehicle interior humidity information, a steering wheel turning angle, a vehicle external illuminance, and the like. Furthermore, the sensor 510 may include an image sensor, and may obtain the driver state information therethrough.

The output device 520 may output an image, a sound, or a vibration in response to control of the processor 540. According to an exemplary embodiment of the present disclosure, the output device 520 may include a display device for outputting the image, and the display device may include a navigation display, a head up display (HUD), a cluster, and the like. The output device 520 may include a speaker for outputting the sound. Furthermore, the output device 520 may include a vibration output device for outputting the vibration, and the vibration output device may be disposed on the seat or the steering wheel in the vehicle.

The storage device 530 may store at least one algorithm for performing calculation or execution of various commands of the processor 540 for operation of the vehicle driving control device according to an exemplary embodiment of the present disclosure. The storage device 530 may include a memory 531 and storage 532, and the memory 531 and the storage 532 may include various types of volatile or non-volatile storage media. For example, the memory 531 may include a read only memory (ROM) 531A and a random access memory (RAM) 531B.

In addition, when the vehicle event occurs during the emergency braking, the storage 530 may store the vehicle event under the control of the processor 540.

The processor 540 may be implemented by various processing devices such as a microprocessor including a semiconductor chip configured to perform the calculation or the execution of the various commands or the like, and may control the operation of the vehicle driving control device according to an exemplary embodiment of the present disclosure. The processor 540 may be a central processing unit (CPU) or a semiconductor device that processes instructions stored in the storage 530 including the memory 531 and the storage 532.

The vehicle driving control device of the present disclosure may further include a network interface that is in communication with electronic devices inside and outside the vehicle, and a user interface input device that receives a user input.

The description above is merely illustrative of the technical idea of the present disclosure, and various modifications and changes may be made by those skilled in the art without departing from the essential characteristics of the present disclosure.

Therefore, the exemplary embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for controlling the driving of the vehicle according to an exemplary embodiment of the present disclosure may resolve the vehicle event that occurs during the emergency braking of the autonomous driving vehicle to improve the safety of the autonomous driving vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are usedto describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling driving of a vehicle, the apparatus comprising:
a sensor configured to obtain state information of the vehicle during autonomous driving of the vehicle;
a processor connected to the sensor and configured to:
perform emergency braking of the vehicle when a risk of collision of the vehicle is predicted based on the obtained state information of the vehicle;
store a vehicle event when the vehicle event occurs after the emergency braking is performed;
transition to a driving mode for resolving the vehicle event when the risk of collision is resolved; and
a storage configured to store an algorithm for an operation of the processor.

2. The apparatus of claim 1, wherein the vehicle event includes an event occurring when the state information of the vehicle is not able to be obtained because of contamination of the sensor or a malfunction of the sensor.

3. The apparatus of claim 1, wherein the processor is configured to determine whether a pre-stored vehicle event exists after the emergency braking is performed.

4. The apparatus of claim 3, wherein the processor is configured to determine whether the vehicle event has occurred when the pre-stored vehicle event does not exist after the emergency braking is performed.

5. The apparatus of claim 3, wherein the processor is configured to determine whether the risk of collision has been resolved when the processor concludes that the pre-stored vehicle event exists after the emergency braking is performed.

6. The apparatus of claim 5, wherein the processor is configured to maintain the emergency braking when the processor concludes that the risk of collision has not been resolved.

7. The apparatus of claim 1, wherein the processor is configured to:
store the vehicle event when the vehicle event occurs after the emergency braking is performed; and
transition to a minimum risk maneuver (MRM) mode when the risk of collision is resolved.

8. The apparatus of claim 7, wherein the minimum risk maneuver includes stopping of the vehicle after decelerating or stopping of the vehicle after a lane change to a shoulder.

9. The apparatus of claim 2, wherein the sensor includes at least one of an image sensor, a Light Detection and Ranging (LiDAR), an accelerator pedal sensor, an emergency light sensor, a door sensor, a rain sensor, an air pressure sensor, a belt sensor, a wheel speed sensor, a yaw rate sensor, a cylinder pressure sensor, a steering wheel sensor, or any combination of each sensor.

10. The apparatus of claim 1, wherein the vehicle event includes an event occurring because of a failure of a device within the vehicle.

11. A method for controlling driving of a vehicle, the method comprising:
obtaining, by a sensor, state information of the vehicle during autonomous driving of the vehicle;
performing, by a processor connected to the sensor, emergency braking of the vehicle when a risk of collision of the vehicle is predicted based on the obtained state information of the vehicle;
storing, by the processor, a vehicle event when the vehicle event occurs after the emergency braking is performed; and
transitioning, by the processor, to a driving mode for resolving the vehicle event when the risk of collision is resolved.

12. The method of claim 11, wherein the vehicle event includes an event occurring when the state information of the vehicle is not able to be obtained because of contamination of the sensor for acquiring the state information of the vehicle or a malfunction of the sensor.

13. The method of claim 11, further including:
determining, by the processor, whether a pre-stored vehicle event exists after the emergency braking is performed.

14. The method of claim 13, further including:
determining, by the processor, whether the vehicle event has occurred when the pre-stored vehicle event does not exist after the emergency braking is performed.

15. The method of claim 13, further including:
determining, by the processor, whether the risk of collision has been resolved when the processor concludes that the pre-stored vehicle event exists after the emergency braking is performed.

16. The method of claim 15, further including:
maintaining, by the processor, the emergency braking when the processor concludes that the risk of collision has not been resolved.

17. The method of claim 11, wherein the vehicle event is stored when the vehicle event occurs after the emergency braking is performed, wherein a driving mode of the vehicle transitions to a minimum risk maneuver (MRM) mode when the risk of collision is resolved.

18. The method of claim 17, wherein the minimum risk maneuver includes stopping of the vehicle after decelerating or stopping of the vehicle after a lane change to a shoulder.

19. The method of claim 12, the sensor includes at least one of an image sensor, a LiDAR, an accelerator pedal sensor, an emergency light sensor, a door sensor, a rain sensor, an air pressure sensor, a belt sensor, a wheel speed sensor, a yaw rate sensor, a cylinder pressure sensor, a steering wheel sensor, or any combination of each sensor.

20. The method of claim 11, wherein the vehicle event includes an event occurring because of a failure of a device within the vehicle.
